(19) United States
(12) Patent Application Publication
(10) Pub. No.: US 2006/0242021 A1
(43) Pub. Date: Oct. 26, 2006

(54) Attrition of affinity points

(75) Inventors: Richard Pavelle, (US); Aharon Zeev Hed, (US)

Correspondence Address: THE FIRM OF KARL F ROSS, 5676 RIVERDALE AVENUE, PO BOX 900, RIVERDALE (BRONX), NY, 10471-0900, US

(73) Assignee: IPEX LLC

(21) Appl. No.: 11/455,579

(22) Filed: Jun. 19, 2006

Related U.S. Application Data
(63) Continuation-in-part of application No. 10/348,918, filed on Jan. 22, 2003.

(51) Int. Cl. G06Q 30/00

(52) U.S. Cl. 705/14

(57) ABSTRACT

Affinity points issued to customers as premiums for other activities or for purchases are maintaining for each customer an account of accrued affinity points. Each customer has a respective account of accrued affinity points that he or she can use to engage in wagering with gaming credits in the form of affinity points from the respective account. Automatically in response to wagering, winnings are credited in terms of affinity points to the account of the customer, losses are debited in terms of affinity points to the account of the customer, and additions to, subtractions from and current balances of affinity points are displayed in the account on the console.

### CROSS REFERENCE TO RELATED APPLICATION

This application is a continuation-in-part of copending application Ser. No. 10/348,918 filed 22 Jan. 2003.

### FIELD OF THE INVENTION

The present invention relates to an affinity-point gaming system. More particularly this invention concerns a new methods of using affinity points, e.g. air-miles generated by the airlines, the travel industry, and various credit cards issuers in general, as wagering means for gaming systems.

### BACKGROUND OF THE INVENTION

Over the last few decades, to enhance customer loyalty, airlines, credit cards, hotel chains, phone companies, rental-car companies, and the like have issued to customers affinity points, referred to by the airlines as frequent-flyer or air-miles, that correspond to dollars spent, miles driven, or mileage actually flown. Typically, these affinity points are redeemable by the airlines in the form of free airline tickets to various destinations, by car companies for free rentals, by hotels for free nights, and so on.

These affinity points have now become a serious future liability to the companies who issue them, and there is a need to limit such a liability. Some issuers have started to introduce affinity points with limited life spans, in essence aging affinity points and thereby reducing the number of outstanding affinity points over time. However, customers have been accustomed to these giveaways and ill will could accrue to issuers if such a tactic is used excessively. There is therefore a need to limit the number of affinity points outstanding, without creating ill will within the loyal population of those customers accruing them, preferably through the attrition of such affinity points in a process that can be viewed positively by the customers.

One such attrition mechanism would allow customers to use their respective affinity points credit as wagers in a system of airborne entertainment units that can act alternatively as gaming consoles. The fact that no monetary consideration is involved might even allow such gaming in jurisdictions where gaming is prohibited by law. Affinity points credit cannot be considered as monetary since there is no fixed exchange rate at any time between affinity points and traditional currencies.

Another advantage of having a method of using affinity points as the means of wagering in in-flight gaming is providing an active alternative to passive entertainment during flight. To the best of our knowledge there is no prior art suggesting the use of affinity points as a means of accumulating winnings or losses while playing gambling games either on airlines or on other transportation means, as well as at various gaming locations, where such gambling is legal.

In-flight entertainment is well known in the prior art, furthermore, systems designed for passenger planes allowing switching between normal entertainment and gaming has been described in the prior art as well. For instance, one such system cited in U.S. Pat. No. 5,618,232 of Martin describes an electronic gaming device system which can be switched between an amusement mode and a gaming or gambling mode, the impetus being that it may be useful for vehicles such as airplanes or boats which move geographically from jurisdictions where gaming is legal to jurisdictions where it is not. However, the system described by Martin provides for wagering only with special tokens or the insertion of a credit or debit card into an appropriate slot, essentially involving monetary consideration for engaging in gaming.

In order to facilitate the introduction of in-flight gaming which utilizes customers' preexisting affinity points, or even affinity points that are due during the flight the passengers are engaged in, means are required to update such customer affinity points accounts and means that are recognizable or readable at the entertainment/gaming console. The prior art does describe such means. For instance, U.S. Pat. No. 5,655,966 to Werdin describes a bar-top gaming system comprising a plurality of player stations interconnected to a table server which is connected to a modem creating a system which provides players with a cash-less way of playing the gaming system. The means of wagering are prepaid magnetic cards and the gaming system includes a credit card magnetic strip reader. However, this system does not enable the use of affinity points as the means by which the wagering transactions are settled. Similarly, U.S. Pat. No. 6,386,457 describes a prepaid entertainment card and methods and systems for using prepaid entertainment cards. However, these are intended for use by television programming providers to collect revenue for providing television programming to subscribers in advance of providing at least some of the programming to the subscribers and cover specifically monetary values rather than affinity points values, and as mentioned before, affinity points cannot be deemed to be equivalent to monetary means. There is therefore a need to provide means and methods for updating affinity points accrued to a customer, such means being capable of interfacing with in-flight entertainment and gaming devices to allow for additions or subtraction of such affinity points, as the outcome of such gaming may dictate.

A method of updating information on credit cards and credit card like devices was described in a co-pending application entitled “A Wireless Communicating Credit Cards” (application Ser. No. 09/790,116 filed 21 Feb. 2001) invented by the present inventors, and this document is hereby incorporated herein by reference. Such a device and variants thereof, as will be further detailed below, could be used as one of the embodiments for the means to update information as required, as well as possible interfacing device with the contemplated in-flight entertainment and gaming systems.

### OBJECTS OF THE INVENTION

It is the main object of the present invention to provide a method of doing business based on the exploitation of existing affinity points in customers accounts for the purpose of engaging in gaming, and thus reduce overall affinity points liabilities while providing gaming entertainment to consumers.

It is another object of the present invention to provide a system in which the then accrued affinity points credit of each consumer can be communicated to the gaming system, and during the gaming process the then current affinity points balance is displayed for viewing by the customer.

It is yet another object of the present invention to provide for updating an affinity-points issuer's data base system at least intermittently, preferably after the game is completed and other data are downloaded to the issuer's database, of each customer affinity points status.

It is a further object of the present invention to provide for a system of affinity points attrition in which all airlines, or at least groups of airlines, provide in-flight gaming systems through which the affinity points attrition can be carried out, this, independently of the source of issue of the affinity points.

It is yet a further object of the present invention to provide for a system of affinity points attrition in which all issuers of affinity points, or at least a sub group of such issuers, provide attrition at various locations where gaming is legal.

It is yet a further object of the instant invention to broaden the use of affinity points to special promotional situations whereby products are offered to affinity-points holders at deep discounts denominated in affinity points, but the sale is conditional on the outcome of a future event. Such a future event can be a sporting event, a political election or any event with an uncertain outcome.

According to yet a further object of the instant invention, attrition of affinity points is achieved by denominating time and price premiums associated with various investment vehicles, particularly options and other financial derivatives.

### SUMMARY OF THE INVENTION

The present invention addresses the point issuer's need to reduce their inventory of affinity points credited to customers' accounts by providing a method that will result in the attrition of the inventory. Specifically, we propose to use such affinity points for gaming in general, for instance during flight and as part of the entertainment package offered to customers. The points could also be used in the place of currency for casino or on-line gambling. Most airplanes and casino game consoles are already equipped with individual displays on which various programs can be viewed. Such displays are controlled from a central processor, and new programs are often loaded on the processor intermittently. The method of affinity points attrition is specifically the use of the affinity points for settling gaming outcomes. Since gaming is designed to ensure that the house (namely, the affinity-point issuer) has a statistical advantage over time, such affinity points will be used up by those participating in the gaming.

This approach has a number of advantages. It will cause affinity points attrition while providing a desirable service to customers, and such a service can probably be implemented in jurisdictions where traditional gaming is prohibited by local law. Furthermore, with the increased distribution of legal gaming locations in the U.S., such attrition can be enabled at such locations.

Another embodiment of the invention relates to means by which a gaming console can interface with a customer's magnetic or electronic card to first identify the customer and his or her affinity points account, and then display, as part of the gaming process the then accrued affinity points. Such means can be a disposable card having on it a magnetic strip, very similar to the format of a traditional credit card. Such a card would be supplied by the affinity-point issuer (or sent by an airline with a ticket when tickets are mailed) on which the magnetic strip has encoded on it both the customer's ID as well as the then accumulated affinity points. Alternatively in an airline situation the customer's boarding pass, which itself has a magnetic strip, can be used for that purpose as well. Yet another alternative to identify the customer and record magnetically his or her accrued affinity points, as well as create the interface between the customer and gaming console, is the use of the customer's affinity points card. This card, which has the format of a traditional credit card, has on it an appropriate magnetic strip that can be used to register the desired information.

Another embodiment of the invention, for those customers having communicating credit cards (such as described in above-cited copending application Ser. No. 09/790,116), simply involves making appropriate arrangements with the credit-card issuer, which can be the affinity-point issuer itself, to provide affinity points data via the same channels described in the application.

In yet another embodiment of the invention, an airline company that is an affinity-point issuer may issue to its customers its own communicating credit cards, install at strategic location within the airport appropriate transceivers. The transceivers can be interfaced to the airline's data base and operate preferably under the Bluetooth communications protocol and thus enable the customer to update his or her communicating credit card with the then current affinity points credit in his or her account, prior to boarding a plane.

In yet another embodiment of the invention, the means of conveying the affinity points accruals to either the customers, or the gaming consoles are card-less and simply involve direct data communication between a central processing unit (CPU) that controls the gaming consoles either in a local-area-network situation such as a casino or in a wide-area-network or internet arrangement, and the specific affinity-point issuer's central database computer. When this approach is used, the customer is expected to input a personal identification code, or any other special code provided by the affinity-point issuer through a keyboard or the like on the gaming console or computer. To the extent that affinity-point issuers already carry on data transfer from their computer to their central database upon completion of a game, the transfer of affinity points information can be transferred at the same time. For an airline as affinity-point issuer this involves both updating affinity points information on incoming customers for the next leg in the airplane's route, as well as downloading status of affinity points attrition or accrual from customers departing the plane at the end of the specific flight. When no such routine data dumping occurs, then a specific transfer of data from the airborne CPU to the affinity-point issuer's data base is carried out, just for updating affinity points information in the affinity-point issuer's central computer and the company's data base system.

Another aspect of the present invention involves arrangements made between various affinity-point issuers, all having gaming systems in which affinity points are used to settle gaming outcomes, as well as between such affinity-point issuers and their partners, such as hotel chains, car rental companies, various credit cards issuers etc. Such arrangements involve prorating of gaming outcomes between the affinity-point issuer on which such gaming is conducted and the original issuer of the affinity points involved in settling such in-flight gaming.

According to an aspect of the invention the attrition of affinity points awarded to a customer comprises the steps of:
issuing affinity points to customers as premiums or for purchases;
maintaining for each customer an account of accrued affinity points; and
enabling a customer having a respective account of accrued affinity points to engage in wagering upon a gaming console or the like with gaming credits in the form of affinity points from the respective account and automatically in response to the wagering,
crediting winnings in terms of affinity points to the account of the customer,
debiting losses in terms of affinity points to the account of the customer, and
displaying additions to, subtractions from and current balances of affinity points in the account on the console.

As previously noted, normally a customer may have a number of accounts for a variety of services or for the purchase of goods which also may provide affinity points or credits or debits which can be treated in terms of affinity points based upon negotiations upon the providers.

In that case, the console can provide the customer with access to a number of accounts maintained by a plurality of providers of goods and services and the method can further comprise the steps of:
automatically calculating prorating of affinity points and debits with respect to each of the accounts of the customer based upon prior negotiations by the providers;
enabling the customer to draw selectively upon the customer's accounts with the providers for the wagering upon the gaming console; and
automatically crediting or debiting based upon the prorating of step (d) the selected account of the customer with winnings or losses in step (c).

When the affinity points are provided to the customer by recording them on a card held in possession of the customer/player, the gaming console or even the customer's own personal computer can interact with the card and affinity points recorded on the card will be debited from the account on a wagering loss.

The account can be maintained at a central station and credited and debited through wireless communication with the gaming console or personal computer and communication between the card and the console or the card and the central station can also be in a wireless manner, or over the internet or standard hard-wired telephone lines.

According to a feature of the invention the method includes the steps of accumulating data with respect to wagering activity from a multiplicity of gaming consoles, e.g. in a casino, with a central processing unit and communicating information with respect to the accounts of respective customers from the central processing unit to a central computer installation of the affinity-point issuer.

The console can be one of a plurality of gaming consoles provided on a multiplicity of aircraft or in one or more casinos and at a plurality of locations. Customer accounts are accessed through wireless communication cards issued to the respective customers, and the cards can be updated intermittently, automatically, or on demand by the respective customers.

### BRIEF DESCRIPTION OF THE DRAWING

The present invention will now be described more fully in detail with reference to the accompanying drawings, in which the preferred embodiments of the invention are shown. The invention, however, should not be construed as limited to the embodiments set forth herein; rather, the following description is provided to make this disclosure thorough and complete and to fully convey the scope of the invention to those skilled in the art. In the drawing:

FIG. 1 is a diagram describing the various participants in the affinity points attrition system of the present invention; and

FIG. 2 is a diagram that describes in general the gaming system and its interaction with a central system.

### SPECIFIC DESCRIPTION

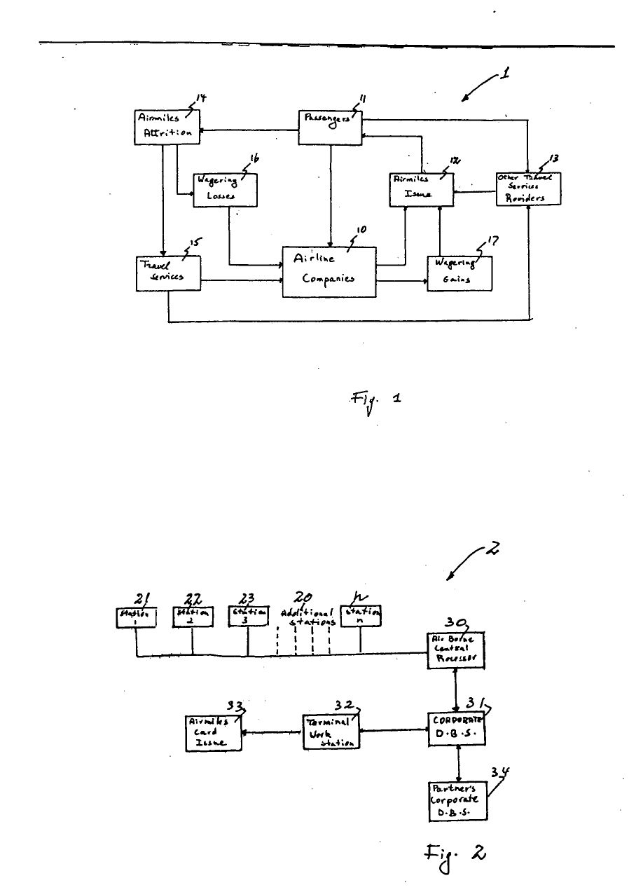

In FIG. 1 we show some of the details of the three elements involved in the method of the present invention, specifically in a gaming system intended for airline use with its passengers as the customers. Specifically, the method involves transactions between an affinity-point issuer, here an airline company 10, and a plurality of its customers 11, resulting in the issuance of affinity points 12. The affinity points credits are most often determined by the distances traveled by customers on the affinity-point issuer, here the airline. In some instances, the affinity-point issuers create partnerships with other travel service providers 13 that can issue affinity points to customers, as well. In the prior art, the attrition of such affinity points 14, was through customers using various travel services 15, either from the affinity-point issuer companies 10, or from their partners 13. This method of attrition of affinity points has associated with it the cost of delivering the travel services (flights, hotel rooms, car rental etc.), and is thus not optimal. In the method of the present invention, a much more cost-effective method of attrition of the affinity points is provided through the use of in-flight gaming and gaming in general. While in-flight gaming has been implemented before, by such companies as Interactive Entertainment limited and Intergame in the US, and Sky Games in the UK, they all use one form or another of monetary payment, mostly through the use of traditional credit cards. None use accrued affinity points as the means of accruing losses or gains during in-flight gaming. However, in the method of doing business of the instant invention, wagering losses, 16 and wagering gains 17, result in attrition and in issuance of affinity points. It should be noted that affinity points do not have a predetermined or fixed monetary value. Instead a fixed amount of affinity points is normally exchangeable for an airline ticket independently of the fares such flights might typically bear. This lack of fixed exchange rate at any given time makes affinity points a nonmonetary instrument. As is typical with gaming systems in general, wagering losses are always greater than wagering gains, and thus net attrition of affinity points accrued to all customers would occur from practicing the method is of the present invention.

Specifically, the method of doing business of the present invention, resulting in attrition of accrued affinity points in customers accounts, consists of:

a. issuing affinity points credits to a plurality of customers by an affinity-point issuer, in association with flights, purchases, or the like customers have completed;

b. maintaining for each customer an account of accrued affinity points;

c. providing consoles that are gaming capable, for instance at a plurality of airline seats, at least on some of the airline's flights (or alternately using the gaming consoles of an existing hotel or casino or even a user's own home computer in an internet-gambling system);

d. providing means enabling each customer to engage in wagering, including means that update each gaming console, or station with the then current accrued affinity points credit in each wagering customer's account; and

e. displaying for the customer the then current affinity points credited to his account, including additions or subtraction to the account resulting from the most recent gaming session engaged in by the customer, and

f. allowing the customers to engage in gaming and debiting affinity points attrition or crediting affinity points additions resulting from the gaming to the customer's affinity points account.

The issuing of affinity points credits can be carried on by non affinity-point issuers entities as well, under special cooperation agreements, or joint marketing agreements between the affinity-point issuer in question and the non affinity-point issuers entities. Such agreements have been made between airlines and other participants in the travel industry, such as hotel chains, rental car companies, long distance affinity-point issuers and other providers of telecommunication services, and even major issuers of credit cards. While the issuance of such affinity points creates a major liability for the involved issuers, such issuance does however, serve as an important marketing incentive to enlist potential new customers for the services and goods provided by the various issuers. It should be understood, however, that attrition of affinity points so issued by non affinity-point issuer companies, can be carried out through any type of gaming as long as these affinity points are credited to each customer affinity points account.

It should also be understood that arrangements can be made between different issuers of affinity points, so as to allow uniform attrition of affinity points when customers engage in gaming. Such arrangements are already in existence between select groups of affinity-point issuers relative to other method of affinity points attrition, such as the use of affinity points in exchange of various travel related services. However, there is no reason that such arrangements not be made between all affinity-point issuers relative to the method of attrition of affinity points of the present invention. Such arrangements could involve, but are not limited to, for instance, the partitioning on a preagreed scale of the attrition of affinity points from cross issuers, as well as the wagering gains when these apply, between the affinity points issuer and the company where the wagering sessions are carried out. In this context, a cross issuer is a affinity-point issuer, or another affinity points issuer, whose issued affinity points are undergoing attrition during in-flight gaming on another affinity-point issuer, not the specific issuer of the specific affinity points used in settling the wagering session.

Thus, in some embodiments of the affinity points attrition methods of the present invention, customer affinity points accrued with any of the issuers of the affinity points, can be used in wagering with any of the participating issuers.

Thus, while here the specific example relates to in-flight wagering, one can visualize other travel service providers, such as hotel chains or cruise ships, providing entertainment means that can be easily converted to gaming console when so desired, within their own facilities, the gaming resulting in credits and debits of affinity points only. Indeed any gaming venue, whether in the organized setting of a casino or via the Internet, can serve for attrition of affinity points according to the instant invention.

FIG. 2 shows a general description of a system 2, with which the method of affinity points attrition can be practiced. It should be understood that in different embodiments of the system, different elements described in FIG. 2 may or may not be used. For instance, in some embodiments of the invention, the system contains a number of entertainment stations, 20 to n, that are connected to an airborne CPU 30 (and its associated drivers and memory devices). While we have shown only four such stations in FIG. 2, it should be understood that essentially all n customer seats on the airplane are each equipped with such stations. Each station is identified by its own identification number (in FIG. 2, essentially from 1 to n, corresponding to the numerals 20, 21, 22 for the stations 1 to 3 respectively, and n for the n^{th} station).

The entertainment stations 20 to n are built in such a manner that they can be converted to gaming consoles when released to fulfill that function by an appropriate command from the airborne CPU, or, alternately, by special means, carried by the customer, such as a magnetic card 33 issued to qualified customers prior to flight from a terminal workstation 32.

The terminal workstation 32 is in communication with the affinity-point issuer's database system 31, to assure correct recording of the accrued affinity points to each qualified customer.

In some embodiments of the invention, the corporate database system 31, is put in communication with the airborne CPU 30, prior to and after each flight to assure correct accounting of the attrition of affinity points from each customer, or in cases some customer's in-flight wagering session resulted in gains, to assure recording of such gains to each customer's affinity-points account.

In embodiments of the invention involving cooperation between other entities issuing affinity points credits, either other affinity-point issuers or other travel related services companies, a connection to such other corporate partners database system 34 is provided. There are a number of possible methods of updating the information from a partner's database system to the affinity-point issuer's own database system. In most cases companies are not inclined for security reasons to provide other companies free access and a permanent communication link to their own data base. Therefore, in such cases, intermittent exchange of information related to customer's affinity points between the affinity-point issuer's database system 31 and its corporate partners database system 34 is carried out. This exchange or update of customer's affinity points credits can be carried out on a monthly basis, a weekly basis or even a daily basis. Appropriate protocols for such exchange of information are already available and practiced between affinity-point issuer companies and their various corporate partners, and thus are not part of the present invention.

Returning now to the means 33 by which each console in the airplane is readied for a wagering session. As mentioned above, one such means is the use of an equivalent to a disposable magnetic card. The magnetic card can be part of the existing boarding pass, that part which the customer carries on board, and on which the customer's seating assignment is provided. Such a boarding card is already issued by most affinity-point issuers with a magnetic strip on it, the magnetic strip being used to embed information such as the flight number, the customer identity etc., and is typically read by a magnetic reader, just prior to boarding the airplane. It is therefore quite easy to embed the additional information relative to the customer's accrued affinity points on such boarding passes and its associated stub. The incorporation of that additional information (accrued affinity points) will not involve any additional instrumentation at the terminal workstation 32. The same magnetic strip that is used to admit a customer on the airplane, can now be used to activate the conversion of the entertainment console (20 to n) at each customer seat on the airplane. When the boarding pass stub, and particularly, the magnetic strip on the stub, is used as means to activate the entertainment console at the customer seat, and convert it to a wagering station, the affinity-point issuer may chose to enable only the console associated with the seat assigned to same customer.

When using the boarding pass stub as the means by which an entertainment console is activated and converted to a wagering station for the customer carrying stub, it is not anticipated that the console would update any information on the stub magnetically. Updates will then be communicated during the next communication between the affinity-point issuer's CPU and the corporate database system. All intermittent updating would be carried out and displayed to the customer on the playing console. When a customer is engaged in airborne travel in which a plurality of embarkation and debarkation steps are contemplated, and boarding passes are issued for each leg of the journey, the affinity-point issuers may find the use of the boarding pass magnetic strip as means of activation of the entertainment consoles and converting the consoles to wagering consoles, difficult, or at least somewhat troublesome. For instance, if two boarding passes are issued for one trip, and each boarding pass stub in the hand of the customer has a record of all of the customer's affinity points, it is possible for such a customer to cause full attrition of its affinity points during wagering session on both legs of his trip, resulting in actual affinity points debit in such a customer account. Affinity points debits are extremely difficult to settle, particularly since they have no well defined monetary values, and thus should be avoided as much as possible.

There are a number of ways to overcome the problem involved with such duplication of records. The simplest one is to allocate to each boarding pass issued on a multiple legs of a trip, only a portion of the affinity points credits accrued in the customer's account. This approach assures that the customer never gets to the point where his in-flight gaming activities result in affinity points debit. Another approach is to limit the number of affinity points that can be subject to gaming attrition on any single boarding pass, and that this limitation be well under the normal level of affinity points credit the customer might have.

In view of some of the limitations involved with using boarding pass stubs and their associated magnetic strips, in some embodiments of the invention, affinity-point issuers may find it advantageous to issue a separate magnetic card 33 issued typically at the terminal workstation 32. Such a disposable magnetic card would be an entertainment console dedicated card, designed specifically to convert the console into a wagering station and be valid for a limited period, such as a period covering only the length of time the expected travel session such a customer might be engaged in. Such a disposable card will have its own magnetic strip on which the customer unique identification as well as his then current affinity points credit would be imprinted at the terminal workstation 32. In some embodiments, such a card would be limited to be used only at the console associated with the seat assigned to the customer, while in other embodiments, the affinity-point issuer may chose to enable such wagering at any console within the aircraft. Clearly, with the customer own unique identification number embedded on the disposable magnetic card, correct assignment of wagering debits and credits to this unique identification, and thus to the unique customer will be enabled. Such data would then be updated and stored at the airborne CPU 30 and in its associated memory devices, for later transfer to the affinity-point issuer's corporate database system as further described below. If such a unique dedicated disposable magnetic card is selected, the playing console would update on the card itself the then current affinity points credit, and thus the same disposable card could be used on a plurality of legs in a single trip. It should be clear, therefore, that at least a segment of the magnetic strip be of the rewritable type magnetic strip that would be the segment where actual accrued affinity points are updated.

Another alternative to a new card issued on every flight would be the use of the customer existing affinity points card, which the affinity-point issuers are typically forwarding to customers when they join their affinity points credit program. Such a card has on it a magnetic strip on which specific data associated with the customer are encoded, including the customer's unique identification number within the affinity-point issuer's database. In one embodiment of the present invention, the affinity points card is provided with a segment of the magnetic strip that is rewritable. Thus, at the terminal workstation 32 the customer may be asked if he desires his gaming privileges, for the flight he is about to embark on, to be activated, and the activation, as well as the then current credit in his affinity points account, is imparted magnetically on that part of the magnetic strip that is rewritable.

The entertainment consoles 20 to n are provided with an appropriate slot containing a magnetic strip reader, and in some embodiments, a magnetic head writer as well, to allow reading data magnetically imparted on any of the various magnetic means described above. Namely, a boarding pass stub, a disposable magnetic card, or the existing affinity points cards typically issued to all members in the various affinity points club the affinity-point issuers have already established. Insertion of the magnetic card into the dedicated slot causes reading of the information relating to the customer, including his unique identification number (which differ between affinity-point issuers). Once the magnetic medium is read by the console, the CPU 30 enables the console to act as a gaming station and the customer can engage in his desired gaming or wagering. A variety of protocols can be used to initiate the gaming session, for instance, once the console identified the customer through reading the data on the magnetic strip, the customer, may first be welcomed to the gaming console, and then his then current affinity points credit be displayed on the console. To the extent that the magnetic medium (any of the boarding pass stub, the disposable magnetic card or the affinity-point issuer issued permanent affinity points card, the latter two, with the rewritable magnetic section on the magnetic strip) bears information on the then current affinity points credit in that the customer's account, that number is displayed. From time to time there might arise a discrepancy between the affinity points credit registered on the magnetic medium and in the airborne CPU's memory. If such occurs it is probably best to display the more current credit displayed by the customer borne magnetic medium, since the updating of the CPU 30 may be delayed relative to information imprinted at the terminal workstation 32 this, because the terminal is in direct contact with the corporate database system, which is assumed to have the most updated data on the customer affinity points credits.

Another alternative to using magnetic media on card like devices, or boarding pass stubs, as the means of providing access to in-flight gaming consoles as well as identifying the customer and obtaining his then current affinity points credit, is the use of an input (numerical only s sufficient) keyboard on the console. When such a keyboard is an integral part of the entertainment console, customers are provided prior to each flight, or on a permanent basis, a unique identification number, which entry on the keyboard would provide access to the entertainment console and convert it to a wagering console. Using this embodiment relies on updating the airborne CPU 30 from the corporate database 31 prior to each flight.

One of the perceived shortcomings associated with any of the three magnetic strip types modalities of interface between the customer and the entertainment consoles, as well as the method involving direct entry of a code (card less method) is the fact that the customer may not a have an easy access to information as to his then current affinity points credit, prior to engaging the gaming console. To alleviate such a shortcoming, the affinity-point issuer may chose to implement a somewhat different strategy of updating and informing customers of their affinity points credit status. In the above-cited co-pending patent application the inventors of the present invention disclosed a communicating credit card and a system of updating such credit cards using existing wireless communication networks. The communication credit cards (CCC), having a display and are updated intermittently (typically once a day automatically by the issuer), or on demand by the card bearer and allows through the display to keep the bearer of the CCC current on his account status. In one embodiment of the present invention, we contemplate that affinity-point issuer companies issue such CCC to their customers, or alternatively, create partnerships with credit card issuers that issue such CCC to their customers. In both cases, the wireless communication and the display features unique to the CCC would enable constant updating of the customer's affinity points current credit and make it readable at any time by the customer on its CCC. In operation the CCC can interface with the entertainment console in the same manner as other magnetic media (since the CCC also has a magnetic strip like any standard credit card), by providing the console with the customer unique identification.

In yet another embodiment of the invention, the affinity-point issuers issue dedicated Communicating Affinity points Cards (CAC) to a plurality of their customers, and install at strategic locations within the airport, short range transceivers, tuned at the frequency of the CAC's receiver. These have the same structural and functional capabilities as the CCC mentioned above, except that their transceivers are dedicated to operate only in conjunction with the airport short range transceivers cited above. The communication protocol could for instance be a variant of the Bluetooth protocol, and when a customer desires to update his cards, he moves to close proximity (typically less than ten feet), to one of the strategically located affinity-point issuer transceivers, pushes a receive button on his CAC, and, as a result, a short message is sent to the affinity-point issuer transceiver that includes the customer's unique ID within the affinity-point issuer's database system. That causes the transceiver to respond with a message containing an update of the customer's affinity points credit. Obviously, the message transmitted by the affinity-point issuer's transceiver contains a code (for instance, utilizing the customer's unique ID) that assures that only the CAC with the ID can decode and store the data transmitted. When using a CAC as the means of updating affinity points to a customer, the same CAC is also used to activate the entertainment console on the airplane, via a similar short range transceiver in the console. Clearly, an additional key marked for instance “play” can be used to activate the console by a short message transmission form the CAC to the console. Once the console is activated, the customer can put back the CAC in his wallet and the console, according to its own schedule will update the CAC on the then current status of his affinity points credit. Obviously, the customer may terminate any wagering session by an on/off switch on the console, and if he then desires to resume a new wagering session, he would activate the console again with his CAC.

Another aspect of the present invention involves methods by which affinity points issued by different issuers can be used to settle in-flight wagering sessions, even though the affinity-point issuer on which the wagering session occurs and the issuer of the affinity points are not the same.

Specifically, the method of doing business of the present invention, resulting in attrition of affinity points in customer's accounts, the affinity points being issued to the customers by a plurality of issuers consists of:

having a plurality of issuers of affinity points credit to a plurality of air travelers, the issuers being one or more of, affinity-point issuer companies, hotel chains companies, car rental companies and other travel industry organization, in association with products and services acquired by the travelers from the issuers;

each of the affinity points issuing organizations maintaining for each customer an account of its accrued affinity points credits, and communicating the credits to other affinity points issuing organizations;

negotiating between the various affinity points issuers and the in-flight gaming providers a prorating coefficient to determine the distribution of affinity points debits or credits resulting from in-flight gaming by customers;

providing entertainment consoles that are gaming capable at a plurality of seats on a plurality of flights;

providing each qualified customer means to engage in wagering during flights, including means that update each gaming console, or station with the then current accrued affinity points credit in each of the customer various affinity points accounts;

displaying for the customer the then current affinity points credited to his account, including additions or subtractions to the account resulting from the most recent gaming session engaged in by the customer, and

allowing the customers to engage in in-flight gaming and prorating affinity points attrition or additions resulting from the gaming between affinity points issuers and providers of in-flight gaming according the rates negotiated in c above.

It should be clear to a person trained in the art, that to the extent affinity-point issuers may want to engage in swap attrition of affinity points, they can simply enable their corporate database system 32 as well as the specific CPU on each departing airplane 30 to accept affinity points cards from swapping affinity-point issuer companies, using intermittent updating of affinity points information in customers' accounts through linking to corporate partners database system 34. Similarly, when using CCC as the medium of interface between an in-flight entertainment console and the customer, any of the various affinity points credit such a customer might possess, might be displayable on the CCC display, and to the extent that swap attrition is engaged in, the customer, through the console interface, can select which of his affinity points credit he would be using in the in-flight wagering session.

In another application of the principles of the instant invention a product such as a plasma television is offered for sale at a price denominated in affinity points, with the caveat that the sale only goes through should, for example the purchaser's home sports team reach the Super Bowl or NBA finals, win the World Series, or some other sports event occurs. If this happens, the television is delivered to the purchaser/bettor. If it does not, the affinity points are forfeited and no merchandise changes hands. This can be viewed as a promotional scheme, but it is clearly packaging the delivery of an expensive product in terms of a sports bet on an uncertain outcome using affinity points, e.g., 20,000 miles gets you the product should the contingent event occur. But of course it is not a gamble per se and is most likely legal in states that generally prohibit gambling.

According to another application of the instant invention, an attractive number of miles is awarded for a product or service purchased or contracted to with cash, but only upon the occurrence of the contingent event. So the consumer agrees to list their house with a real estate brokerage and the consumer receives 100,000 miles should his or her home team, as above, win the specified outcome or some other selected event occurs. If it does not, the listing remains but no miles are awarded.

In a further system according to the invention the affinity points are used in investment-related contexts, for example, stock futures exchange that is run entirely with airline miles. One person, for example, is long an IBM stock future (a derivative) in the amount of 1,000 miles per dollar of appreciation in IBM stock. Since this is a derivatives market, someone has been matched in a limit order exchange market, and has shorted the same quantity. This is a zero sum derivatives market, but the miles are subject to attrition through brokerage, commission, and clearinghouse fees payable in miles. Furthermore, airline miles must be posted as margin to secure the credit worthiness of the trades. While these miles are pledged to the clearinghouse, the clearly are “off the market” and cannot be redeemed—therefore promoting the attrition objective.

While in the present disclosure we have described the use of affinity points for in-flight gaming and wagering, as well as in any gaming locations in general, it should be understood that casino games represent only one form of gaming. In the future there is an expectation that affinity-point issuers will make available to their customers football, basketball, baseball and hockey games for viewing as well as wagering. The same would apply to wagers on other sporting events as well as dog and horse racing and the outcome of any potential competitions or races, including various political races.

The above description of methods of attrition of affinity points as well as various means of updating affinity points accounts and interfacing between the customer and the entertainment consoles has been provided to illustrate preferred embodiment of the invention. It should be recognized that departures ma be made therefrom within the scope of the invention, as defined by the appended claims and equivalents thereof. Obvious modifications will become apparent to those of ordinary skills in the art.

We claim:

1. A method of processing customer affinity-point accounts to promote attrition thereof, the method comprising the steps of:
(a) issuing affinity points to customers as premiums for other activities or for purchases;
(b) maintaining for each customer an account of accrued affinity points; and
(c) enabling a customer having a respective account of accrued affinity points to engage in wagering at a gaming console with gaming credits in the form of affinity points from the respective account and automatically in response to the wagering,
crediting winnings in terms of affinity points to the account of the customer,
debiting losses in terms of affinity points to the account of the customer, and
displaying additions to, subtractions from and current balances of affinity points in the account on the console.

2. The method defined in claim 1 wherein the console provides the customer with access to a number of accounts maintained by a plurality of providers of goods and services, the method further comprising the steps of:
(d) automatically calculating prorating of affinity points and debits with respect to each of the accounts of the customer based upon prior negotiations by the providers;
(e) enabling the customer to draw selectively upon the customer's accounts with the providers for the wagering upon a gaming console; and
(f) automatically crediting or debiting based upon the prorating of step (d) the selected account of the customer with winnings or losses in step (c).

3. The method defined in claim 2 wherein a plurality of the gaming consoles are provided on each of a multiplicity of flights of an airline constituting the affinity-point issuer providing the affinity points.

4. The method defined in claim 2 wherein a plurality of the gaming consoles are in a casino.

5. The method defined in claim 2 wherein the gaming console is the customer's personal computer connected to an internet gaming system.

6. The method defined in claim 3 wherein the gaming consoles are also provided at a waiting facility for a traveler.

7. The method defined in claim 2 wherein affinity points are provided to the customer by recording an affinity-mile credit on a card held in possession of the customer, the gaming console interacting with the card, affinity points recorded on the card being debited from the account upon a wagering loss and being credited to the account upon a wagering win.

8. The method defined in claim 2 wherein the account is maintained at a central station and is credited and debited through wireless communication with the gaming console.

9. The method defined in claim 2, further comprising assigning an account number to the player, the player activating the gaming console by inputting the account number thereto.

10. The method defined in claim 9 wherein the account number is recorded on a card assigned to the player and the gaming console has a card reader for reading the card and automatically responding to the recorded account number.

11. The method defined in claim 1 wherein the account is at least in part recorded on and updated on a card.

12. The method defined in claim 11 wherein the card is updated by wireless communication with a central station.

13. The method defined in claim 1 wherein the gaming console is accessed by a card issued to the customer.

14. The method defined in claim 13 wherein the card is provided by an affinity-point issuer as a disposable card.

15. The method defined in claim 1, further comprising the steps of accumulating data with respect to wagering activity from a multiplicity of gaming consoles on an aircraft with a central processing unit thereon and communicating information with respect to the accounts of respective customers from the central processing unit to a central ground computer installation of the affinity-point issuer.

16. The method defined in claim 1 wherein the console is one of a plurality of gaming consoles provided on a multiplicity of aircraft and at a plurality of locations in an airport, customer accounts are accessed through wireless communication cards issued to the respective customers, and the cards have displays which are updated intermittently automatically or on demand by the respective customers.

17. The method defined in claim 16, further comprising the step of communicating with the cards through short-range transceivers provided in the airport.

18. The method defined in claim 1, further comprising the step of issuing the customer a boarding pass for a flight and recording on the boarding pass an air-mile credit adapted to be used in the gaming console.

19. The method defined in claim 18 wherein the boarding pass is provided with a magnetic strip in which the air-mile credit is recorded, the method further comprising the step of updating the air-mile credit recorded in the magnetic strip based upon the wagering at the gaming console.

20. The method defined in claim 1 wherein the wagering is structured such that affinity points form at least part of consideration offered by the customer in a consumer sales transaction such that, if a selected event occurs, the sale takes place and a purchase price is paid at least in part by the wagered affinity points, but if the selected event does not occur, the affinity points are forfeited to the seller without the sale taking place.

21. A method of processing customer affinity-points account to promote attrition thereof, the method comprising the steps of:
(a) issuing affinity points to customers as premium for other activities or purchases;
(b) maintaining for each customer an account of accrued affinity points; and
(c) offering for sale merchandise at deep discounts denominated in affinity points, and prepaid in said affinity points, said sale to take place if a predetermined event occurs, and if said event does not occur, said prepaid affinity points are forfeited.

22. The method defined in claim 21 whereas said event is a sporting event and said occurrence is a predetermined outcome of said sporting event.

23. The method defined in claim 21 whereas said event is a political race and said occurrence is a predetermined outcome of said race.

24. A method of processing customer affinity-points account to promote attrition thereof, the method comprising the steps of:
(a) issuing affinity points to customers as premium for other activities or purchases;
(b) maintaining for each customer an account of accrued affinity points; and
(c) establishing a market in securities options and other derivatives, whereby the time and price premiums as well as transaction costs are denominated in said affinity points; and
(d) matching buy and sell orders in said options and derivatives denominated in said affinity points and causing affinity points attrition through transaction costs.
